(19) United States
(12) Patent Application Publication
(10) Pub. No.: US 2010/0187928 A1
(43) Pub. Date: Jul. 29, 2010

(54) MOTOR

(75) Inventors: Young-Jae Jeon, Suwon-si (KR); Sang-Jin Park, Hwaseong-si (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 12/508,210

(22) Filed: Jul. 23, 2009

(30) Foreign Application Priority Data
Jan. 29, 2009 (KR) 10-2009-006952

(51) Int. Cl. H02K 5/16; H02K 5/24; H02K 7/08

(52) U.S. Cl. 310/90; 310/51

(57) ABSTRACT

A motor is disclosed. The motor can include a shaft, a bearing that rotatably supports the shaft, a rotor that is coupled to the shaft and to which at least one magnet is coupled, a stator having one side facing the magnet, a base supporting the bearing, and an attachment portion interposed between the base and one side of the stator. The spindle motor may be used to firmly secure the stator to the base, while minimizing the transfer of vibrations from the stator to the base to improve the noise and vibration properties of the spindle motor.

### CROSS-REFERENCE TO RELATED APPLICATIONS

This application claims the benefit of Korean Patent Application No. 10-2009-0006952, filed with the Korean Intellectual Property Office on Jan. 29, 2009, the disclosure of which is incorporated herein by reference in its entirety.

### BACKGROUND

1. Technical Field

The present invention relates to a motor.

2. Description of the Related Art

Following the trend towards smaller products in the electronics industry, much effort has been devoted to developing smaller motors. This is especially true for spindle motors used in the hard disks of various portable products, such as PMP's (portable multimedia players), handheld game consoles, and MP3 players.

As recorded media are being produced in higher densities, the demand is growing for higher-precision rotations and lower noise and vibration in motors, such as the spindle motor, used in operating a recorded medium.

A typical spindle motor can be composed mainly of a rotor, which is the rotating portion to which one or more magnets are coupled, a stator, which faces the rotor and generates electromagnetic forces, and a base, which supports the rotor and stator.

Here, if the stator is not firmly secured to the base, the spindle motor may not maintain structural stability. However, increasing the coupling force between the stator and the base may make it easier for vibrations generated in the stator to be transferred to the base, thereby exacerbating vibration- and noise-related problems in the overall spindle motor.

### SUMMARY

An aspect of the invention provides a motor that can maintain a reliable coupling between the stator and the base of the motor while providing improved noise and vibration properties.

Another aspect of the invention provides a motor that includes: a shaft, a bearing that rotatably supports the shaft, a rotor that is coupled to the shaft and to which at least one magnet is coupled, a stator having one side facing the magnet, a base supporting the bearing, and an attachment portion interposed between the base and one side of the stator.

Here, the magnet may be coupled to a perimeter of the rotor. The stator can include an annular body, a tooth (or teeth) extending towards an inner side of the body, a coil wound around the tooth, and a face portion that faces the magnet and is coupled to an end of the tooth.

At least one opening can be formed in the base for holding the coil, and the attachment portion can be interposed between the base, a bottom surface of the tooth, and the coil, inside the opening.

A portion of the stator on a reverse of the side facing the magnet can be separated from the base.

Yet another aspect of the invention provides a motor that includes: a shaft, a bearing that rotatably supports the shaft, a base that supports the bearing, a rotor that is coupled to the shaft and to which at least one magnet is coupled, and a stator that has one side facing the magnet and the reverse side separated from the base.

The magnet can be coupled to a perimeter of the rotor, and the stator can include an annular body, a tooth (or teeth)extending towards an inner side of the body, a coil wound around the tooth, and a face portion, which faces the magnet and which is coupled to an end of the tooth.

An opening can be formed in the base for holding the coil, and the motor can further include an attachment portion interposed between the base and one side of the stator. The attachment portion can be interposed between the base, a bottom surface of the tooth, and the coil, inside the opening.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a cross-sectional view of a spindle motor according to an embodiment of the invention.

FIG. 2 is a magnified view of portion A in FIG. 1.

FIG. 3 is a bottom view of a portion of a spindle motor according to an embodiment of the invention.

FIG. 4 is a graph illustrating noise levels of a spindle motor according to an embodiment of the invention.

### DETAILED DESCRIPTION

The motor according to certain embodiments of the invention will be described below in more detail with reference to the accompanying drawings. Those components that are the same or are in correspondence are rendered the same reference numeral regardless of the figure number, and redundant descriptions are omitted.

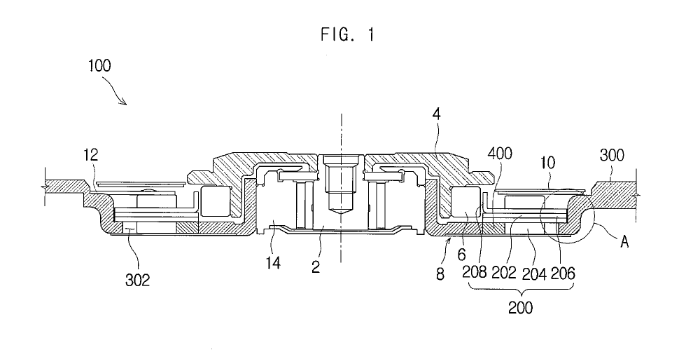

FIG. 1 is a cross-sectional view of a spindle motor 100 according to an embodiment of the invention. As in the example shown in FIG. 1, a spindle motor 100 according to an embodiment of the invention can include a shaft 2, a bearing 14 that rotatably supports the shaft 2, a rotor 4 coupled to the shaft 2 and to which at least one magnet 6 is coupled, a stator 200 that has one side facing the magnet 6, a base 300 supporting the bearing 14, and an attachment portion 400 positioned between the base 300 and one side of the stator 200. The spindle motor 100 can be used to firmly secure the stator 200 to the base 300, while minimizing the transfer of vibrations from the stator 200 to the base 300 to improve the noise and vibration properties of the spindle motor 100.

The shaft 2 can be coupled to the center of rotation of the rotor 4 and can be rotatably supported by the bearing 14. The rotor 4 can have a generally cylindrical shape and can include a space underneath in which the bearing 14 may be held. The magnet 6 can be coupled to a perimeter of the rotor 4.

In certain examples, the bearing 14 can be, for example, an oil-impregnated bearing 14, which contains lubricating oil. The bearing 14 may be supported by the base 300. The bearing 14 can be held in the space under the rotor 4, so that the overall thickness of the spindle motor 100 may be reduced.

One side of the stator 200 can face the magnets 6 to generate an electromagnetic interaction with the magnets 6 that drives the rotor 4. The stator 200 can be composed of a body 206, teeth 202, coils 204, and face portions 208. The body 206 can have an annular shape. The teeth 202 can be formed in certain intervals on the body 206, extending towards the inner side of the body 206. A coil 204 can be wound around each tooth 202.

Formed at the end of the tooth 202 may be the face portion 208, which faces the magnet 6. The face portions 208 can be formed at the ends of the teeth 202, such that the face portions 208 face the magnets 6, and can collect the magnetic flux generated by the coils 204 to direct the flux to the magnets 6.

Since the stator 200 has a generally annular shape, the one side of the stator 200 facing the magnet 6 can be the inner side of the stator 200. Also, the side of the stator 200 on the reverse of the side facing the magnet 6 can be the outer side of the stator 200.

Here, a flexible printed circuit board (FPCB) 12 can provide electrical connections to the coils 204, while a shield 10 can cover the upper side of the stator 200 to prevent the escape of magnetic flux.

Attachment portions 400 can be positioned between the inner side of the stator 200 and the base 300. The attachment portions 400 can be made from adhesive that is applied to and cured at portions of the base 300 where the inner side of the stator 200 is to be mounted. The attachment portions 400 can serve to secure the stator 200 to the base 300.

Openings 302 can be formed in the base 300 to coincide with the positions of the coils 204 of the stator 200, with each opening 302 providing a space in the base 300 for holding the coil 204. The coils 204 can thus be held in the openings 302, and the inner side and outer side of the stator 200 can be mounted on the base 300.

Here, space can be formed in an opening 302, between the base 300, the coil 204, and a bottom surface of the tooth 202. The attachment portion 400 can be interposed in this space to secure the stator 200 to the base 300.

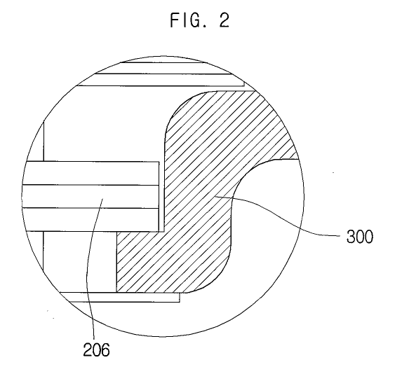

FIG. 2 is a magnified view of portion A in FIG. 1. As illustrated in FIG. 2, the outer side of the stator 200, i.e. the perimeter of the body 206, can be separated from the base 300. In this way, the portions of the stator 200 facing the magnets 6 can be secured to the base 300 to provide the stator 200 with structural stability, while the portions of the stator 200 on the reverse side can be separated from the base 300 to prevent the transfer of vibrations from the stator 200 to the base 300 and thus reduce overall vibrations and noise in the spindle motor 100.

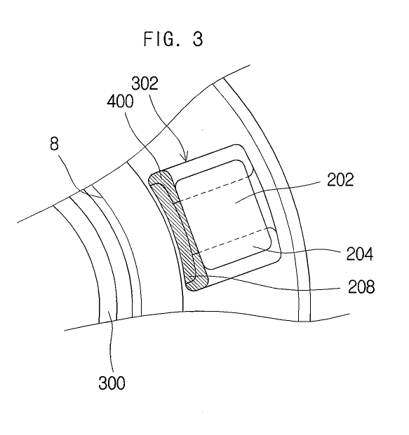

FIG. 3 is a bottom view of a portion of a spindle motor 100 according to an embodiment of the invention. As in the example shown in FIG. 3, the coil 204 can be held in the opening 302, and the attachment portion 400 can be interposed in the space between the base 300, the bottom surface of the tooth 202, and the coil 204.

As illustrated in FIGS. 1 and 3, a sealing paper 8 can be attached to the outer side of the opening 302. The sealing paper 8 may prevent the adhesive from leaking to the exterior of the spindle motor 100.

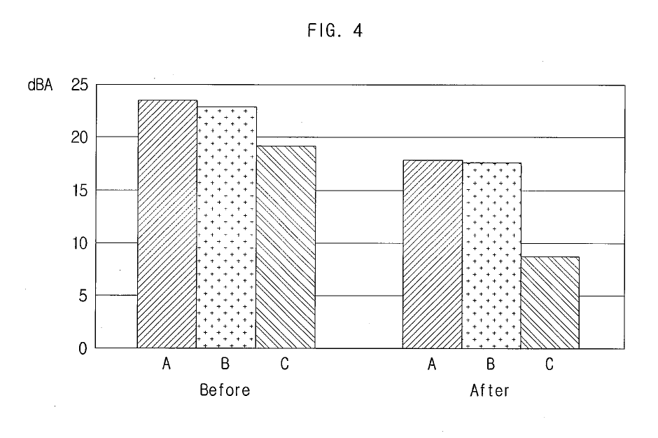

FIG. 4 is a graph illustrating noise levels of a spindle motor 100 according to an embodiment of the invention. In FIG. 4, the results for a conventional spindle motor (the “Before” results in FIG. 4) are for a spindle motor structure similar to that shown in FIG. 1, but in which the stator 200 is secured to the base 300 by means of adhesive applied to all areas of the stator 200 adjacent to the base 300 and adhesive applied all around the coils 204. The test results for a spindle motor 100 according to an embodiment of the invention are illustrated as the “After” results in FIG. 4.

Bar “A” in FIG. 4 represents the noise of the spindle motor measured at all frequencies, and bar “B” represents the results after inputting an operating frequency of 1280 Hz in the spindle motor, while bar “C” represents the results after inputting an operating frequency of 2550 Hz.

As shown in FIG. 4, using a structure for securing the stator 200 according to an embodiment of the invention can yield an overall noise-reduction effect of 30% or greater.

While an embodiment of the invention has been described using an example in which the teeth 202 extend towards an inner side of the body 206, and the magnets 6 of the rotor 4 are arranged inside, it is apparently possible to conceive a structure in which the teeth 202 extend towards an outer side of the body 206, and the magnets 6 of the rotor 4 are arranged outside. In this case, the attachment portions 400 can be interposed between the side of the stator 200 facing the magnets 6 and the base 300, while the side of the stator 200 on the reverse of the side facing the magnets 6 can be separated from the base 300.

While the spirit of the invention has been described in detail with reference to particular embodiments, the embodiments are for illustrative purposes only and do not limit the invention. It is to be appreciated that those skilled in the art can change or modify the embodiments without departing from the scope and spirit of the invention.

What is claimed is:

1. A motor comprising:
a shaft;
a bearing rotatably supporting the shaft;
a rotor coupled to the shaft, the rotor having at least one magnet coupled thereto;
a stator having one side facing the magnet;
a base supporting the bearing; and
an attachment portion interposed between the base and one side of the stator.

2. The motor of claim 1, wherein the magnet is coupled to a perimeter of the rotor.

3. The motor of claim 2, wherein the stator comprises:
an annular body;
a tooth extending towards an inner side of the body;
a coil wound around the tooth; and
a face portion coupled to an end of the tooth, the face portion facing the magnet.

4. The motor of claim 3, wherein at least one opening is formed in the base, the coil held in the opening.

5. The motor of claim 4, wherein the attachment portion is interposed between the base, a bottom surface of the tooth, and the coil, inside the opening.

6. The motor of claim 1, wherein a portion of the stator is separated from the base, the portion of the stator being a reverse side of the side facing the magnet.

7. A motor comprising:
a shaft;
a bearing rotatably supporting the shaft;
a base supporting the bearing;
a rotor coupled to the shaft, the rotor having at least one magnet coupled thereto; and
a stator having one side facing the magnet and the reverse side separated from the base.

8. The motor of claim 7, wherein the magnet is coupled to a perimeter of the rotor.

9. The motor of claim 8, wherein the stator comprises:
an annular body;
a tooth extending towards an inner side of the body;
a coil wound around the tooth; and
a face portion coupled to an end of the tooth, the face portion facing the magnet.

10. The motor of claim 9, wherein at least one opening is formed in the base, the coil held in the opening.

11. The motor of claim 10, further comprising an attachment portion interposed between the base and one side of the stator.

12. The motor of claim 11, wherein the attachment portion is interposed between the base, a bottom surface of the tooth, and the coil, inside the opening.
